(19) United States
(12) Patent Application Publication
(10) Pub. No.: US 2026/0237040 A1
(43) Pub. Date: Aug. 13, 2026

(54) DETECTING FUNCTIONAL IMPAIRMENT OF CAMERA-MONITORED INSECT TRAPS

(71) Applicant: Bayer Aktiengesellschaft, Leverkusen (DE)

(72) Inventors: Matthias Tempel, Köln (DE); Fabian Christian Born, Bad Berleburg (DE); Martjin Diederik Polman, Reichshof (DE); Sven Meyer zu Eißen, Witten (DE)

(21) Appl. No.: 19/153,674

(22) PCT Filed: Feb. 2, 2024
(86) PCT No.: PCT/EP2024/052592

§ 371 Date: Aug. 5, 2025

(30) Foreign Application Priority Data
Feb. 6, 2023 (EP) 23155179.7

(51) Int. Cl. G06T 7/00; G06V 10/74; G06V 10/764; G06V 10/774; G06V 10/82

(52) U.S. Cl. CPC G06T 7/0002; G06V 10/761; G06V 10/764; G06V 10/774; G06V 10/82; G06T 2207/20076; G06T 2207/20081; G06T 2207/20084

(57) ABSTRACT

The systems, methods and computer programs disclosed herein relate to the automated recognition of functional impairments with camera-monitored insect traps using machine learning methods.

### TECHNICAL FIELD

The systems, methods and computer programs disclosed herein relate to the automated recognition of functional impairments with camera-monitored insect traps using machine learning methods.

### INTRODUCTION

WO2018054767A1 discloses an insect trap that is visited by a user in order to check whether insects have entered the insect trap. The user uses a smartphone to generate an image recording of the insects in the trap. A computer program is used to detect, count and/or identify the insects depicted in the image recording in automated fashion.

WO2020058175A1 and WO2020058170A1 disclose an insect trap equipped with a camera. The camera captures images of a collection area of the insect trap, in which insects accumulate, in automated fashion. The images are transmitted, by way of a transmission unit, to a separate computer system, where they are reviewed by a user or analyzed using image recognition algorithms in order to determine the number of insects in the collection area and/or to identify the insects.

The insect traps disclosed in WO2020058175A1 and WO2020058170A1 have the advantage over the insect trap disclosed in WO2018054767A1 that the user does not have to visit the insect traps in order to check whether insects have entered the insect traps.

It is possible, in the case of a camera-monitored insect trap, that a function may become impaired over time. By way of example, it is possible that a liquid used in the insect trap to immobilize insects evaporates over time. It may be the case that the liquid level in the insect trap drops to a level at which insects are no longer immobilized. Another possible functional impairment may be contamination of the collection area and/or of optical elements of the camera (for example a lens). Further possible functional impairments are listed later on in the description.

A functional impairment leads to the function to be performed by the insect trap no longer being performed, or no longer being performed to a sufficient extent.

### SUMMARY

This problem is addressed by the subjects of the independent claims of the present disclosure. Preferred embodiments may be found in the dependent claims, the description and the drawings.

The present disclosure describes means by way of which it is possible to recognize a functional impairment of a camera-monitored insect trap at an early stage.

A first subject of the present disclosure is a computer-implemented method for recognizing a functional impairment with a camera-monitored insect trap. The recognition method comprises:
receiving an image recording, wherein the image recording shows at least part of a collection area of an insect trap,
providing a trained machine learning model, wherein the machine learning model is configured, and has been trained on the basis of training data, to distinguish image recordings of insect traps with a functional impairment from image recordings of insect traps without a functional impairment,
feeding the image recording to the trained machine learning model,
receiving information from the machine learning model, wherein the information indicates whether the image recording shows an insect trap with a functional impairment,
in the event that the image recording shows an insect trap with a functional impairment: outputting a message that the insect trap, shown at least partially in the image recording, has a functional impairment.

A further subject of the present disclosure is a computer system comprising:
an input unit,
a control and computing unit, and
an output unit,
wherein the control and computing unit is configured
to cause the input unit to receive an image recording, wherein the image recording shows at least part of a collection area of an insect trap,
to feed the received image recording to a machine learning model, wherein the machine learning model is configured, and has been trained on the basis of training data, to distinguish image recordings of insect traps with a functional impairment from image recordings of insect traps without a functional impairment,
to receive information from the machine learning model, wherein the information indicates whether the received image recording shows an insect trap with a functional impairment,
to cause the output unit to output a message, wherein the message indicates that the insect trap, shown at least partially in the received image recording, has a functional impairment when the information output by the machine learning model indicates that the received image recording shows an insect trap with a functional impairment.

A further subject of the present disclosure is a non-volatile computer-readable storage medium storing software commands that, when they are executed by a processor of a computer system, cause the computer system to carry out the following steps:
receiving an image recording, wherein the image recording shows at least part of a collection area of an insect trap,
feeding the received image recording to the trained machine learning model, wherein the machine learning model is configured, and has been trained on the basis of training data, to distinguish image recordings of insect traps with a functional impairment from image recordings of insect traps without a functional impairment,
receiving information from the machine learning model, wherein the information indicates whether the received image recording shows an insect trap with a functional impairment,
in the event that the information indicates that the received image recording shows an insect trap with a functional impairment: outputting a message that the insect trap, shown at least partially in the received image recording, has a functional impairment.

A further subject of the present disclosure is a system comprising:
an insect trap,
a camera,
a control unit,
an analysis unit,
a transmission unit, and
an output unit,
   wherein the control unit is configured to cause the camera to generate one or more image recordings of a collection area of the insect trap,
   wherein the analysis unit is configured to feed the one or more generated image recordings to a machine learning model, wherein the machine learning model is configured, and has been trained on the basis of training data, to distinguish image recordings of insect traps with a functional impairment from image recordings of insect traps without a functional impairment,
   wherein the analysis unit is configured to receive information from the machine learning model, wherein the information indicates whether the one or more image recordings shows/show an insect trap with a functional impairment,
   wherein the transmission unit is configured to transmit the information and/or the one or more image recordings to a separate computer system,
   wherein the output unit is configured to output the information.

A further subject of the present disclosure is a kit comprising an insect trap and a computer program product, wherein the insect trap comprises a camera or means for accommodating a camera, wherein the computer program product comprises program commands, wherein the program commands are able to be loaded into a main memory of a computer system and cause the computer system to carry out the following steps:
receiving an image recording, wherein the image recording shows at least part of a collection area of an insect trap,
feeding the received image recording to the trained machine learning model, wherein the machine learning model is configured, and has been trained on the basis of training data, to distinguish image recordings of insect traps with a functional impairment from image recordings of insect traps without a functional impairment,
   receiving information from the machine learning model, wherein the information indicates whether the received image recording shows an insect trap with a functional impairment,
   in the event that the information indicates that the received image recording shows an insect trap with a functional impairment: outputting a message that the insect trap, shown at least partially in the received image recording, has a functional impairment.

### BRIEF DESCRIPTION OF THE DRAWINGS

FIG. 1 schematically shows, by way of example, the training of a machine learning model.

FIG. 2 schematically shows the use of a trained machine learning model to recognize a functional impairment with an insect trap.

FIG. 3 schematically shows a further example of the training of a machine learning model.

FIG. 4 schematically shows a further example of the use of a trained machine learning model to recognize a functional impairment with an insect trap.

FIG. 5 schematically shows, by way of example, a computer-implemented method for training a machine learning model, in the form of a flowchart.

FIG. 6 schematically shows, by way of example, a computer-implemented method for recognizing a functional impairment with a camera-monitored insect trap, in the form of a flowchart.

FIG. 7 schematically shows, by way of example, one embodiment of a computer system of the present disclosure.

FIG. 8 schematically shows, by way of example, a further embodiment of a computer system of the present disclosure.

### DETAILED DESCRIPTION

The invention will be explained in more detail below without distinguishing between the subjects of the present disclosure (method, computer system, computer-readable storage medium, system, kit). Rather, the following explanations are intended to apply analogously to all of the subjects of the invention, irrespective of the context (method, computer system, computer-readable storage medium, system, kit) in which they are described.

Where steps are indicated in an order in the present description or in the claims, this does not necessarily mean that the invention is limited to the indicated order. Rather, it is conceivable that the steps may also be carried out in a different order or else in parallel with one another, unless one step builds on another step, which absolutely requires that the step building on the previous step be carried out subsequently (this will however become clear in the individual case). The orders that are indicated are therefore preferred embodiments of the present disclosure.

In certain places, the invention will be explained in more detail with reference to drawings. The drawings illustrate specific embodiments having specific features and combinations of features that are intended primarily for illustrative purposes; the invention should not be understood as being limited to the features and combinations of features illustrated in the drawings. Furthermore, statements made in the description of the drawings in relation to features and combinations of features are intended to be generally applicable, that is to say applicable to other embodiments as well, and not limited to the embodiments shown.

The present disclosure describes means by way of which a functional impairment with a camera-monitored insect trap is recognized at an early stage and automatically.

An insect trap is understood to mean a device that insects visit accidentally or deliberately and that allows a user to recognize whether insects are present in an area. By way of example, the area may be a field or a greenhouse for cultivating crops, a building (for example a warehouse for storing food and/or animal feed, a hospital, a retirement home, a school and/or the like), a room in a building (for example a living room, a bedroom, a canteen, a ward and/or the like), or another area.

The term insect comprises all stages from the larva (caterpillar, pseudo-caterpillar) up to the adult stage. The term insect trap should not be understood to mean that only insects are able to enter the insect trap. The term insect trap has been chosen because such traps are mainly used for checking whether insects are present in an area. However, the insect trap may also be used to recognize the presence of other arthropods (lat. Arthropoda), for example the presence of spiders. It is likewise conceivable for the insect trap to be used to recognize the presence of a defined species in an area, and accordingly be set up to attract and/or immobilize and/or recognize this defined species.

Examples of such defined species are: codling moth, aphid, thrips, summer fruit tortrix, Colorado potato beetle, cherry fruit fly, cockchafer, European corn borer, plum fruit moth, rhododendron leafhopper, turnip moth, scale insect, gypsy moth, spider mite, European grapevine moth, walnut husk fly, glasshouse whitefly, oilseed rape stem weevil, cabbage stem weevil, rape pollen beetle, cabbage shoot weevil, brassica pod midge or cabbage stem flea beetle, or a forestry pest, such as for example aphid, steelblue jewel beetle, bark beetle, oak splendour beetle, oak processionary moth, green oak tortrix, spruce webworm, common furniture beetle, great brown bark eater, common pine sawfly, pine beauty, pine looper, lesser spruce sawfly, pine moth, horse chestnut leaf miner, gypsy moth, brown powderpost beetle, mosquitoes (for example Asian tiger mosquito).

The insect trap may have means for immobilizing insects. By way of example, the insect trap may comprise a dish filled with a liquid (for example water or an aqueous solution). It is conceivable for the liquid to comprise a surfactant in order to reduce the surface tension and/or an agent for preventing algae formation and/or an attractant for attracting insects. Insects that enter the liquid may for example drown in the liquid or be captured by the liquid. The insect trap may also comprise a surface coated with glue or another sticky substance to which insects become stuck. However, an insect trap does not have to have means for immobilizing insects; it may be sufficient, for the intended use of the insect trap, for insects to enter the collection area and remain here for a time.

The insect trap may comprise means for attracting insects. Some insects (for example rape seed pests such as the oilseed rape stem weevil) are attracted by a yellow color, for example. Some insects (for example male food moths) may be attracted by a pheromone. It is also possible to use food to attract the insects. Some insects are attracted by electromagnetic radiation in a defined wavelength range. The insect trap may be equipped with an electromagnetic radiation source that emits electromagnetic radiation in a defined wavelength range (or in a plurality of wavelength ranges). However, the insect trap does not have to have attractants; it may be sufficient, for the intended use of the insect trap, for insects to accidentally stray into the trap or come into contact therewith.

The insect trap comprises a collection area. The collection area is an area that may be visited by insects (or other arthropods). This may be a flat surface of a tablet or card or the like. It may also be the bottom of a vessel. It is possible that the insect trap comprises a plurality of collection areas. It is also conceivable for the insect trap to have various collection areas, for example one collection area for (specific) pests and another collection area for (specific) useful insects.

The collection area preferably comprises a flat, smooth or structured surface with a round, oval, elliptical, angular (triangular, tetragonal, pentagonal, hexagonal or generally n-sided, where n is an integer greater than or equal to three) cross section. The cross section is preferably round or rectangular (in particular square). The walls may extend upward from the surface, resulting in a vessel. The vessel may for example be cylindrical, conical or box-shaped. It preferably has a round or angular cross section, and the walls extend conically upward from the bottom, wherein the bottom surface and wall surface preferably run at an angle of more than 90° and less than 120° relative to one another. In the case of an angular cross section, the corners may be rounded.

The bottom of the vessel may have markings and/or a structure allowing automated focusing of the camera and/or representing a reference, in order for example to be able to determine the size of an insect. The bottom of the vessel may have depressions, as described for example in WO2022243150A1, in order to isolate insects in the collection area. Isolation simplifies the automated detection, counting and/or identification of insects in the collection area.

The collection area may be part of a trap mechanism for pests, such as for example a yellow trap dish or an optionally sticky color tablet.

Preferably, the insect trap is a trap as described in WO2020058175A1, WO2020058170A1,WO2021213824A1 or WO2022243150A1.

The insect trap is a camera-monitored insect trap. This means that a camera is arranged and oriented such that it is able to generate image recordings of a collection area of the insect trap.

A camera is understood to mean a device that is able to generate image recordings in digital form and store them and/or provide them via an interface. A camera usually comprises an image sensor and optical elements. The image sensor is a device for recording two-dimensional images from light by electrical means. This usually involves semiconductor-based image sensors, such as for example CCD (CCD=charge-coupled device) or CMOS (CMOS=complementary metal-oxide semiconductor) sensors. The optical elements (lenses, stops and the like) serve to image the object, a digital image recording of which is intended to be generated, as sharply as possible on the image sensor.

By way of example, the camera may be a component of a smartphone or tablet computer.

The camera is used to generate digital image recordings of the collection area or of part thereof. The generated image recordings may be used (i) to recognize whether one or more insects are in the collection area (detection of insects), (ii) to count insects in the collection area and/or (iii) to identify insects, that is to say establish what the insect is (subclass, superorder, order, suborder, family, genus, species, stage and/or sex).

To image the collection area on one or more image sensors, a light source that illuminates the collection area is required, so that light (electromagnetic radiation in the infrared, visible and/or ultraviolet region of the spectrum) is scattered/reflected by the illuminated collection area in the direction of the camera. Daylight may be used for this purpose. However, it is also conceivable to use an illumination unit that ensures defined illumination independent of daylight. This is preferably installed laterally next to the camera, such that the camera does not cast shadows onto the collection area.

It is also conceivable to position an illumination source underneath the collection area and/or next to the collection area, illuminating the collection area “from below” and/or “from the side”, while a camera generates one or more image recordings “from above”.

It is conceivable for multiple illumination sources to illuminate the collection area from different directions.

The term “light” and “illumination”, incidentally, should not be understood to mean that the spectral region is limited to visible light (around 380 nm to around 780 nm). It is likewise conceivable to use electromagnetic radiation with a wavelength below 380 nm (ultraviolet light: 100 nm to 380 nm) or above 780 nm (infrared light: 780 nm to 1000 μm) for illumination. The image sensor and the optical elements are usually matched to the electromagnetic radiation used.

The camera-monitored insect trap comprises a control unit. The control unit may be a component of the camera or a separate device. The control unit is configured to cause the camera to generate one or more image recordings of a collection area or part thereof. The control unit may be a computer system, as described later in the description. The camera may be a component of such a computer system.

The one or more image recordings may be single image recordings or sequences of image recordings (for example video recordings).

The control unit may be configured to cause the camera to generate image recordings at defined points in time (for example once a day at 12 noon) and/or repeatedly at defined periods of time (for example every hour between 7 am and 8 pm) and/or when a defined event occurs (for example after sunrise when a defined brightness is reached, or as a result of detecting an insect using a sensor) and/or as a result of a command given by a user. The control unit may be a component of the camera or be a device that is independent of the camera and is able to communicate with the camera via a wired or wireless connection (for example Bluetooth).

The insect trap furthermore comprises a transmission unit. The transmission unit may be used to transmit image recordings and/or information to a separate computer system. The transmission is preferably carried out over a radio network, for example over a cellular network. The transmission unit may be a component of the control unit or be a unit independent of the control unit.

The insect trap may comprise a reception unit in order to receive commands from a separate computer system.

The transmission unit and/or the reception unit may be components of a computer system, as described later in the description.

The image recordings generated by the camera are usually analyzed in automated fashion in order to detect, count and/or identify the insects in the collection area or part thereof. This analysis may be performed by an analysis unit, which may be a component of the insect trap; however, this analysis may also be performed by an analysis unit that may be a component of a separate computer system to which the image recordings are transmitted by way of the transmission unit of the insect trap. The analysis unit may be a component of a computer system, as described later in the description. The analysis unit may comprise a trained machine learning model that is configured and trained to detect, count and/or identify insects depicted in image recordings. Details regarding the automated detection, counting and/or identification of insects in image recordings are described in publications on this topic (see for example: D. C. K. Amarathunga et al.: Methods of Insect Image Capture and Classification: A Systematic Literature Review, Smart Agricultural Technology, Volume 1, 2021, 100023; C. Zhu et al.: Insect Identification and Counting in Stored Grain: Image Processing Approach and Application Embedded in Smartphones, Mob. Inf. Syst. 2018, 5491706:1-5, WO2020058175A1, WO2020058170A1).

The image recordings generated by the camera may also be used to recognize a functional impairment with the camera-monitored insect trap.

A functional impairment denotes a state of the insect trap that affects one or more components of the insect trap or the insect trap as a whole in such a way that one or more functions are no longer carried out or are no longer carried out to a sufficient extent or are no longer carried out optimally. By way of example, a function might no longer be carried out to a sufficient extent or no longer be carried out optimally if the impairment slows down or hampers the function or the result is inferior or the result is incorrect.

Functions that are typically meant to be performed by the insect trap are attracting insects and/or immobilizing insects and/or isolating insects in the collection area and/or illuminating the collection area with one or more light sources and/or generating image recordings of the collection area and/or sending image recordings and/or other/further information to a separate computer system and/or other/further functions.

A functional impairment may in this case be an impairment that is currently causing the function to be affected or that will cause the function to be affected in the near future if no measures are taken to maintain the functions.

### Examples of Functional Impairments Are Listed Below

liquid level has dropped below a lower threshold value: If the collection area of the insect trap is designed as a vessel, a liquid (for example water or an aqueous solution) in the vessel may be used to immobilize insects. If the amount of liquid in the vessel drops below a threshold value, it may be the case that insects are no longer immobilized. This constitutes a functional impairment.

It is also possible that insects are only partially covered by liquid, and the partial coverage of the insects with liquid hampers automated detection, counting and/or identification. By way of example, as a result of the partial coverage, the contours of insects might not be clearly visible in an image recording, and/or unwanted reflections may arise at the interfaces between liquid and insect.

It may also be the case that the liquid has completely evaporated, that is to say the collection area has dried out.

It is also possible that the insect trap is provided with a storage vessel from which liquid automatically flows into the collection area when the liquid level in the collection area has dropped below a defined threshold value (as described for example in WO2021213824A1). It is possible that an image recording shows the amount of liquid remaining in the storage vessel. If the amount of liquid contained in the storage vessel has dropped below a defined residual amount, it is possible that no more liquid will be able to flow from the storage vessel into the collection area in the near future; a functional impairment is expected.
liquid level has risen above an upper threshold value: It is possible that the liquid level in the collection area has risen above an upper threshold value, for example as a result of rainwater. It is possible that liquid flows out in uncontrolled fashion over a wall of the vessel forming the collection area, and in the process insects floating on the liquid are removed from the collection area.
collection area is contaminated: It is possible that contaminants have accumulated in the collection area, these hampering detection, counting and/or identification of insects. Contaminants may fully or partially conceal insects or clump with them (form agglomerates). Contaminants may be leaves and/or other plant parts, dust, secretions from insects and/or from other animals and/or the like.
collection area is exhausted: It is possible that a large number of insects have already accumulated in the collection area, these completely or partially overlapping and/or aggregating to form accumulations. This may impair the automated detection, counting and/or identification of the insects.
algae formation in the collection area: It is possible that algae form in a liquid in the collection area. The algae may hamper the automated detection, counting and/or identification of insects in the collection area.
foam in the collection area: In the case of a trap dish filled with liquid, foam may form on the liquid over time. This foam may completely or partially block the view of insects in the collection area. In addition, it is possible that insects are no longer immobilized by the liquid.
ice formation or icing: In the case of a trap dish filled with liquid, the liquid may freeze at low temperatures. It is thereby possible that insects are no longer immobilized by the liquid.
field of view restrictions: It is possible that spider webs in the insect trap cause the camera to no longer have a clear view of the collection area. In addition to spider webs, spiders in front of a lens of the camera may also be a problem. Constructs of insects (for example larval pupae) and/or plant parts (for example twigs, leaves, roots) in the insect trap may also completely or partially obscure the collection area from the view of the camera.
camera and/or optical elements are contaminated: Deposits on a lens of the camera may cause an impairment. It is possible that a deposit restricts the field of view of the camera and the complete original collection area is no longer imaged. It is conceivable for deposits to cause blurred or partially blurred image recordings. It is possible that water (for example rainwater) and/or another liquid (for example a liquid from the collection area) gets onto a lens and restricts the field of view and/or causes blurring in the image recording.
illumination source(s) defective and/or contaminated: If the insect trap is equipped with one or more illumination sources, it may be the case that one or more of these illumination sources emits no electromagnetic radiation or less electromagnetic radiation and/or that, as a result of contamination of the one or more illumination sources, a sufficient amount of electromagnetic radiation no longer enters the collection area and illuminates it. The absent or reduced illumination may cause loss of contrast and/or increased noise in the image recordings, which in turn may hamper the automated detection, counting and/or identification of insects.
unwanted reflections: It is possible that reflections are observed in the image recordings at certain times, these reflections resulting for example from sunlight entering the collection area at a defined angular range. It is possible that sunlight enters the collection area at certain times of day and/or times of the year and causes unwanted reflections there. It is possible that such unwanted reflections caused by sunlight were not observed when the insect trap was set up and/or did not appear until later. It is possible that the insect trap has been moved from its original position and/or pose to another position and/or pose where the reflections occur by wind and/or by an animal and/or precipitation.
change in position and/or pose of components of the insect trap and/or of the insect trap as a whole: It is conceivable for the position and/or pose and/or orientation of components of the insect trap and/or the insect trap as a whole to change over time. Such changes may be the result of weather influences (for example precipitation, wind, solar irradiation), interactions with animals and/or humans and/or earth tremors (for example earthquakes, falling trees, vehicles driving past).

If an insect trap filled with a liquid was originally set up such that the flat bottom of the vessel containing the liquid is oriented horizontally, that is to say perpendicular to the direction of gravity, so that the surface of the liquid is at the same distance from the bottom of the vessel at all points, it is possible that the orientation has changed and that the liquid surface is no longer at the same distance from the bottom at all points. This may cause distortion in the image recordings.

It is also possible that the insects accumulate at one or more points of the collection vessel.

It is furthermore possible that the orientation of the camera and/or of optical elements of the camera with respect to the collection area has changed, and the collection area is no longer imaged or is no longer imaged completely and/or is imaged in completely or partially blurred fashion.
camera is defective: It is possible that the camera has a defect and the generated image recordings are not suitable for automated detection, counting and/or identification of insects in the collection area. By way of example, it is possible that the image recordings that are generated are noisy and/or have a color cast and/or have a low contrast range and/or are completely black or white.
camera does not generate images of the collection area: It is possible that the camera generates image recordings during maintenance of the insect trap and/or when the insect trap is assembled that do not show the collection area of the insect trap, but rather for example other components of the insect trap and/or the environment of the insect trap. Such recordings may be unsuitable for automated detection, counting and/or identification of insects in the collection area of the insect trap. Such image recordings may also be identified using the means described in this description and rejected, for example. Rejection may mean that a rejected image recording is not analyzed in automated fashion in order to detect, count and/or identify insects in the collection area.

The functional impairments and/or their effects are recorded graphically in image recordings generated by the camera in the camera-monitored insect trap. The image recordings are used to train a machine learning model to automatically recognize such functional impairments. The term “automatically” means without human involvement.

Such a “machine learning model” may be understood to mean a computer-implemented data processing architecture. The model is able to receive input data and to supply output data on the basis of said input data and model parameters. The model is able to learn a relationship between the input data and the output data through training. During training, model parameters may be adjusted so as to supply a desired output for a particular input.

During the training of such a model, the model is presented with training data from which it is able to learn. The trained machine learning model is the result of the training process. Besides input data, the training data comprise the correct output data (target data) that the model is supposed to generate on the basis of the input data. During training, patterns that map the input data onto the target data are recognized.

In the training process, the input data of the training data are input into the model, and the model generates output data. The output data are compared with the target data. Model parameters are altered so as to reduce the deviations between the output data and the target data to a (defined) minimum. To modify the model parameters in order to reduce the deviations, it is possible to use an optimization procedure, such as for example a gradient procedure.

The deviations may be quantified using a loss function. A loss function of this kind may be used to compute a loss for a given pair of output data and target data. The goal of the training process may be to alter (adjust) the parameters of the machine learning model so as to reduce the loss for all pairs of the training dataset to a (defined) minimum.

By way of example, if the output data and the target data are numbers, the loss function may be the absolute difference between these numbers. In this case, a high absolute loss may mean that one or more model parameters need to be altered to a substantial degree.

By way of example, for output data in the form of vectors, difference metrics between vectors such as the mean squared error, a cosine distance, a norm of the difference vector such as a Euclidean distance, a Chebyshev distance, an Lp norm of a difference vector, a weighted norm or any other type of difference metric between two vectors may be chosen as the loss function.

In the case of higher-dimensional outputs, such as for example two-dimensional, three-dimensional or higher-dimensional outputs, an element-by-element difference metric may for example be used. As an alternative or in addition, the output data may be transformed into for example a one-dimensional vector before a loss value is computed.

In the present case, the machine learning model receives one or more image recordings as input data. The model may be trained to output information for the one or more image recordings as to whether the one or more image recordings is/are one or more image recordings of an insect trap with a functional problem or one or more image recordings of an insect trap without a functional problem. In other words, the machine learning model may be trained to distinguish image recordings of insect traps with a functional problem/functional problems from image recordings of insect traps without a functional problem/functional problems.

The machine learning model may be trained to assign the one or more image recordings to one of at least two classes, wherein at least one first class represents image recordings of insect traps that do not have a functional impairment and at least one second class represents image recordings of insect traps that have a functional impairment.

The machine learning model is trained on the basis of training data. The training data comprise a multiplicity of image recordings of one or more insect traps. The term “multiplicity” means more than 10, preferably more than 100. The image recordings act as input data. Some of the image recordings may show the one or more insect traps without functional impairments, that is to say in a state in which they are functioning properly. Other image recordings may show the one or more insect traps with a functional impairment. The training data may also comprise target data in addition to the input data. The target data may indicate, for each image recording, whether the insect trap depicted in the image recording has a functional impairment or whether it does not have a functional impairment. The target data may also comprise information as to what functional impairment is present in the specific case and/or the seriousness thereof and/or its degree of severity.

The machine learning model may be trained to assign each image recording to exactly one of two classes, wherein exactly one class represents image recordings of insect traps that do not have functional impairments and the other class represents image recordings of insect traps that have a functional impairment or multiple functional impairments. In other words, the machine learning model may be trained to perform a binary classification. In such a case, it is sufficient for information to be present for each of the individual image recordings of the training data as to whether the image recording shows an insect trap with a functional impairment or whether the image recording shows an insect trap without a functional impairment. In such a case, the machine learning model may be trained to recognize insect traps with one (or more) functional impairments, regardless of the one or more functional impairments in question in each case. It is also possible to train a machine learning model to perform a feature extraction for each image recording input into the machine learning model and to generate a compressed representation of the image recording. The machine learning model may be trained in this case to generate similar compressed representations for image recordings that do not show an insect trap with a functional impairment. If the trained machine learning model is fed with an image recording of an insect trap with a functional impairment, then the trained machine learning model generates a compressed representation of the image recording of the insect trap with the functional impairment that is able to be distinguished from the compressed representations of the image recordings of insect traps without a functional impairment. Such training in which the machine learning model is trained only to recognize whether a functional impairment or no functional impairment is present may be useful if a user is only interested in finding out whether the insect trap is functioning properly or whether an intervention is required to rectify a functional impairment (whatever this may be).

The machine learning model may also be trained to recognize a specific functional impairment. The specific functional impairment may be one of the functional impairments described above in this description. It is possible that a user is only interested in finding out whether the specific functional impairment is present (for example the liquid level is too low). The machine learning model may be trained to assign each image recording to one of two classes, wherein one class represents image recordings of insect traps that have the specific functional impairment and the other class represents image recordings of insect traps that do not have the specific functional impairment, that is to say in which either no functional impairment at all is present or a functional impairment other than the specific functional impairment is present. In such a case, the training data, for each image recording, comprise information as to whether the specific functional impairment with the depicted insect trap is present or not present.

However, the machine learning model may also be trained to assign each image recording to one of more than two classes, wherein the classes represent for example the severity of the specific functional impairment. By way of example, a first class may represent image recordings of insect traps in which the specific functional impairment does not occur (for example no contamination); a second class may represent image recordings of insect traps in which the specific functional impairment occurs to a slight extent (for example slight contamination); a third class may represent image recordings of insect traps in which the specific functional impairment occurs to a significant extent (for example significant contamination). A slight functional impairment may mean that the insect trap is still sufficiently functional but that maintenance will be necessary in the future in order to avoid a further functional impairment. A significant or severe functional impairment may mean that immediate maintenance is necessary. It is also conceivable to have more than the three gradations mentioned, for example four (for example no impairment, slight impairment, moderate impairment, severe impairment) or more and/or other gradations. In such a case, the training data, for each image recording, comprise information as to whether the functional impairment is present in the depicted insect trap and, if it is present, the seriousness thereof and/or the severity with which it occurs.

However, the machine learning model may also be trained to recognize more than one specific functional impairment, that is to say to distinguish different functional impairments from one another. By way of example, the machine learning model may be trained to learn a number n of specific functional impairments, wherein n is an integer greater than 1. The machine learning model may be trained to assign each image recording to one of at least n+1 classes, wherein a first class represents image recordings of insect traps that do not have a functional impairment, and each of the at least n remaining classes represent image recordings of insect traps that show one of the n specific functional impairments. It is also possible that the machine learning model is additionally trained to recognize two or more degrees of severity of one or more of the n specific functional impairments. In other words, the machine learning model may be trained to recognize, for one or more of the n specific functional impairments, the seriousness thereof and/or the degree of severity with which it occurs. In such a case, the training data, for each image recording, comprise information as to whether a functional impairment is present, if a functional impairment is present, which specific functional impairment is present, and for one or more of the specific functional impairments, the seriousness thereof and/or the severity with which it occurs.

Existing camera-monitored insect traps may be used to generate the training data described in this description. Camera-monitored insect traps may be operated for a period of time. The image recordings generated by the camera-monitored insect traps may be analyzed by one or more experts. The one or more experts may provide each image recording with one of the items of information (annotations) required for the training, which are then used as target data. The one or more experts may look at the image recordings and provide each image recording with information as to whether the respective image recording shows an insect trap without a functional impairment or with a functional impairment. If necessary to train the machine learning model, any image recording showing an insect trap with a functional impairment may be provided with information as to the seriousness of the functional impairment and/or the severity with which it occurs. If necessary to train the machine learning model, any image recording showing an insect trap with a functional impairment may be provided with information as to which specific functional impairment is present in each case.

When training the machine learning model, the image recordings are fed (sequentially) to the machine learning model. The machine learning model may be configured to assign each image recording to one of at least two classes. The class assignment may be output by the machine learning model, for example in the form of a number. By way of example, the number 0 may thus represent image recordings of insect traps that do not show a functional impairment; the number 1 may represent image recordings of insect traps that have a first specific functional impairment; the number 2 may represent image recordings of insect traps that have a second specific functional impairment, etc.

It is also possible that the machine learning model is configured to output a vector for each image recording, wherein the vector, for each functional impairment, at a coordinate of the vector, comprises a number indicating whether the respective functional impairment is shown (that is to say is present in the depicted insect trap) or not shown (that is to say is not present in the depicted insect trap) in the image recording. Such a procedure has the advantage that various functional impairments that are present simultaneously with an insect trap may also be recognized alongside one another. In such a vector, the number 0 may indicate that a specific functional impairment is not present and the number 1 may indicate that the specific functional impairment is present. The position in the vector (coordinate) at which the respective number occurs may provide information as to which specific functional impairment is involved in each case.

It is also possible that the machine learning model is configured to indicate, for one or more (specific) functional impairments, a probability of the (specific) functional impairment occurring with the respectively depicted insect trap. By way of example, the probability may be given as a value in the range from 0 to 1, wherein the greater the probability, the greater the value.

It is also possible that the machine learning model is configured to indicate, for one or more (specific) functional impairments, a degree of severity with which the (specific) functional impairment occurs in the respectively depicted insect trap.

The output (output data) output by the machine learning model on the basis of an input image recording may be compared with the target data. A loss function may be used to quantify deviations between the output data and the target data. In an optimization procedure (for example a gradient procedure), the deviations may be reduced by modifying model parameters. If the deviations reach a (predefined) minimum or reach a plateau, the training may be terminated. The trained machine learning model may be used to recognize one or more functional impairments, and optionally their severity, with an insect trap.

For this purpose, a new image recording of a collection area of an insect trap may be fed to the machine learning model. The term “new” in this case means that the corresponding image recording has not already been used to train the machine learning model. The trained machine learning model assigns the new image recording to one of the at least two classes that were used when training the machine learning model. The trained machine learning model outputs information as to the class to which the machine learning model has assigned the image recording. It is possible that the trained machine learning model outputs information as to the probability of one or more functional impairments being present and/or the seriousness thereof and/or the degree of severity with which they occur.

The output from the machine learning model may be displayed on a screen, printed out on a printer, stored in a data memory and/or transmitted to a separate computer system (for example via a network).

The output from the machine learning model may be used to automatically reject image recordings of insect traps with a functional impairment (or with multiple functional impairments). In such a case, an image recording of an insect trap is analyzed in a first step according to the present disclosure for the presence of a functional impairment (or multiple functional impairments), before it is analyzed in a subsequent second step in order to detect, count and/or identify insects in the collection area, depicted in the image recording, of the insect trap. It is possible that only those image recordings for which the analysis in the first step revealed that they do not have a functional impairment are fed to the second step for detecting, counting and/or identifying insects. It is also possible that only those image recordings for which the analysis in the first step revealed that they do not have a functional impairment or have only a functional impairment with a low degree of severity are fed to the second analysis for detecting, counting and/or identifying insects. It is likewise possible that only image recordings with specific functional impairments or with specific functional impairments with a predefined degree of severity or a minimum number of present different functional impairments are rejected. It is possible that a user may specify beforehand which image recordings are to be rejected.

If the trained machine learning model assigns an image recording to a class that represents image recordings of insect traps with a functional impairment, a message may be output to a user. Such a message may inform the user that there is a functional impairment with an insect trap. The message may inform the user that an image recording is not analyzed in order to detect, count and/or identify insects because the insect trap depicted at least partially in the image recording has a functional impairment. A message to a user may comprise the following information: which insect trap is affected (for example, a location of the insect trap may be indicated), what functional impairment is present, the severity of the functional impairment, what measures are able to be taken to restore the full functionality of the insect trap, when should the measures be taken in order to avoid a further functional impairment. It is also possible that the image recording in which the trained machine learning model has recognized a functional impairment is likewise output to the user, so that the user themselves is able to get an idea of the functional impairment.

If the output of the trained machine learning model is a probability value for the presence of a functional impairment, this probability value may be compared with a predefined threshold value. If the probability value is greater than the threshold value or equal to the threshold value, a message about the presence of a functional impairment with an insect trap may be output to a user. If the probability value is less than the threshold value, the image recording may be fed to an analysis for detecting, counting and/or identifying insects in the collection area of the insect trap.

It is conceivable for there to be more than one threshold value with which the probability value is compared. By way of example, it is possible that there is an upper threshold value and a lower threshold value. In the case of a probability value below the lower threshold value, the probability of a functional impairment being present is so low that the user does not need to be informed. The image recording may be fed to an analysis for detecting, counting and/or identifying insects in the collection area of the insect trap. If the probability value is above the upper threshold value, the probability of a functional impairment being present is so high that a message regarding the presence of a functional impairment is output to the user. It is possible that the image recording is not supplied to an analysis for detecting, counting and/or identifying insects. If the probability value is in the range from the lower threshold value to the upper threshold value, there is some uncertainty as to whether or not a functional impairment is present. This uncertainty may result from the fact that the image recording is of comparatively low quality. It is possible that a command is transmitted to the control unit of the insect trap to generate a further image recording in order to also feed this further image recording to the trained machine learning model in order to recognize a functional impairment. It is possible that parameters are altered when generating the further image recording in order to increase the quality of the image recording. By way of example, the exposure time may be increased and/or the illumination of the collection area may be increased by one or more illumination units and/or filters (color filters, polarization filters and/or the like) may be used. The further image recording may then provide clarity as to whether or not a functional impairment is present. However, it is also possible that the uncertainty about the presence of a functional impairment results from the fact that a functional impairment is only just emerging, that is to say only a comparatively slight functional impairment (for example slight contamination) is present. It is possible that the control unit of the insect trap is prompted by a command to reduce the time interval between two consecutive image recordings. Image recordings are then taken at a reduced time interval in order to recognize a further functional impairment and/or an increase in the degree of severity of the functional impairment at an early stage.

Threshold values may be set by an expert based on their experience. However, they may also be set by a user. It is possible that the user themselves may decide whether they would like to be informed already when there is a lower probability of a functional impairment being present, or whether the user would rather be informed when the probability of a functional impairment being present is comparatively high.

The machine learning model of the present disclosure may be an artificial neural network or comprise same. An “artificial neural network” comprises at least three layers of processing elements: a first layer having input neurons (nodes), a kth layer having at least one output neuron (nodes), and k-2 inner layers, wherein k is a natural number and is greater than 2.

The input neurons serve to receive the input representations. There is usually one input neuron for each pixel of an image recording that is input into the artificial neural network. There may be additional input neurons for additional input values (for example information regarding the image recording, the depicted insect trap, camera parameters, weather conditions when the image recording is generated and/or the like).

The output neurons may serve to output information as to the class to which the input image recording has been assigned and/or the probability of it having been assigned to the class.

The processing elements of the layers between the input neurons and the output neurons are connected to one another in a predetermined pattern with predetermined connection weights.

The neural network may be trained for example using a backpropagation method. In this case, the most reliable possible mapping of the input data onto the target data is sought for the network. The quality of prediction is described by a loss function. The goal is to minimize the loss function. In the case of the backpropagation method, an artificial neural network is taught by altering the connection weights.

In the trained state, the connection weights between the processing elements contain information regarding the relationship between image recordings and functional impairments of the insect traps depicted in the image recordings, said information being able to be used to recognize a functional impairment of an insect trap on the basis of a new image recording at an early stage. The term “new” in this case means that the new image recording has not already been used when training the artificial neural network.

A cross-validation method may be used to divide the data into training datasets and validation datasets. The training dataset is used in the backpropagation training of the network weights. The validation dataset is used to check the accuracy of prediction with which the trained network is able to be applied to unknown (new) data.

The artificial neural network may be what is known as a convolutional neural network (CNN for short) or may comprise same.

A convolutional neural network (“CNN”) is capable of processing input data in the form of a matrix. This makes it possible to use, as input data, image recordings represented in the form of a matrix (for example width x height x color channels). A neural network, for example in the form of a multilayer perceptron (MLP), on the other hand requires a vector as input, that is to say, in order to use an image recording as input, the pixels of the image recording would have to be rolled out in a long chain one after the other. This means that multilayer perceptrons are for example not capable of recognizing objects in an image recording independently of the position of the object in the image recording. The same object at a different position in the image recording would have a different input vector.

A CNN normally consists essentially of an alternately repeating array of filters (convolutional layer) and aggregation layers (pooling layer) terminating in one or more layers of fully connected neurons (dense/fully connected layer).

The scientific literature describes numerous architectures of artificial neural networks used to assign an image to a class (image classification). Examples are Xception (see for example: F. Chollet: Xception: Deep Learning with Depthwise Separable Convolutions, 2017, 1800-1807, 10.1109/CVPR.2017.195), ResNet (see for example: J. Liang: Image classification based on RESNET, Journal of Physics: Conference Series, 2020, 1634, 012110), EfficientNet (see for example: T. Mingxing Tan et al.: EfficientNet: Rethinking Model Scaling for Convolutional Neural Networks, arXiv:1905.11946v5), DenseNet (see for example: G. Wang et al.: Study on Image Classification Algorithm Based on Improved DenseNet, Journal of Physics: Conference Series, 2021, 1952, 022011), Inception (see for example J. Bankar et al.: Convolutional Neural Network based Inception v3Model for Animal Classification, International Journal of Advanced Research in Computer and Communication Engineering, 2018, Vol. 7, Issue 5) and others (see for example: M. Tripathi: Analysis of Convolutional Neural Network based Image Classification Techniques. Journal of Innovative Image Processing, 2021, 3, 100-117; K. He et al.: Deep Residual Learning for Image Recognition, arXiv:1512.03385v1; M. Aamir et al.: An Optimized Architecture of Image Classification Using Convolutional Neural Network, International Journal of Image, Graphics and Signal Processing, 2019, 11, 30-39).

The machine learning model of the present disclosure may have such an architecture or a comparable architecture.

The machine learning model of the present disclosure may be a transformer or comprise same. A transformer is a model that is able to translate one sequence of characters into another sequence of characters, and in the process take into account dependencies between distant characters. Such a model may be used for example to translate text from one language into another. A transformer comprises series-connected encoders and series-connected decoders. Transformers have already been successfully used to classify images (see for example: A. Dosovitskiy et al.: An image is worth 16×16 Words: Transformers for image recognition at scale, arXiv:2010.11929v2; A. Khan et al.: Transformers in Vision: A Survey, arXiv:2101.01169v5).

The machine learning model of the present disclosure may have a hybrid architecture in which for example elements of a CNN are combined with elements of a transformer.

The machine learning model of the present disclosure may be initialized using standard procedures (random initialization, He initialization, Xavier initialization, etc.). However, it may also be pretrained on the basis of publicly accessible pre-annotated images (see for example https://www.image-net.org). The training of the machine learning model may thus accordingly be based on initialization or pretraining and may also include transfer learning, so that only parts of the weights/parameters of the machine learning model are retrained.

The machine learning model may have an autoencoder architecture. An “autoencoder” is an artificial neural network that may be used to learn efficient data encodings in an unsupervised learning process. In general, the objective of an autoencoder is to learn a compressed representation for a dataset and thus extract essential features. This allows it to be used for dimension reduction by training the network to ignore “noise”. An autoencoder comprises an encoder, a decoder, and a layer between the encoder and the decoder, which has a lower dimension than the input layer of the encoder and the output layer of the decoder. This layer (often referred to as bottleneck, encoding or embedding) forces the encoder to generate a compressed representation of the input data that minimizes noise and is sufficient for the decoder to reconstruct the input data. The autoencoder may thus be trained, for an input image recording, to generate a compressed representation of the image recording. By way of example, the autoencoder may be trained solely on the basis of image recording of insect traps that do not have a functional impairment. However, the autoencoder may also be trained on the basis of image recordings showing insect traps with and without a functional impairment. If the autoencoder is trained, the decoder may be discarded and the encoder may be used to generate a compressed representation for each input image recording. If a new insect trap is installed, a first image recording of the insect trap may be generated after installation. This first image recording, which shows the insect trap without a functional impairment, may be used as a reference. The first image recording may be used as a basis for generating a compressed representation using the encoder of the trained autoencoder. This compressed representation is the reference representation. During operation of the insect trap, image recordings generated by the camera of the insect trap may be used as a basis for generating compressed representations using the encoder. The more similar a compressed representation is to the reference image recording, the less likely it is that a functional impairment is present. The more a compressed representation differs from the reference image recording, the more likely it is that a functional impairment is present. The similarity between representations may be quantified using a similarity or distance metric. Examples of such similarity or distance metrics are cosine similarity, Manhattan distance, Euclidean distance, Minkowski distance, Lp norm, Chebyshev distance. If a distance metric exceeds a predefined threshold value or if a similarity metric falls below a predefined threshold value that may be set by an expert or specified by a user, a message may be output that a functional impairment is present and/or an image recording may be rejected.

One example of an autoencoder architecture is the U-net (see for example O. Ronneberger et al.: U-net: Convolutional networks for biomedical image segmentation, International Conference on Medical image computing and computer-assisted intervention, pages 234-241, Springer, 2015, https: //doi.org/10.1007/978-3-319-24574-4_28).

It is also possible, for the machine learning model of the present invention, to use an architecture as described for example in the following publication: J. Dippel, S. Vogler, S. Höhne: Towards Fine-grained Visual Representations by Combining Contrastive Learning with Image Reconstruction and Attention-weighted Pooling, arXiv:2104.04323v2. In addition to an encoder and a decoder, the autoencoder described therein also has a projection head that takes the compressed representation generated by the encoder as a basis for generating an output that indicates whether the image recording shows an insect trap with a functional impairment or without a functional impairment. In other words, not only is the autoencoder trained to generate a compressed representation of the input data and to reconstruct the input data on the basis of the compressed representation, but the autoencoder is also trained at the same time to distinguish image recordings of insect traps with a functional impairment from image recordings of insect traps without a functional impairment (contrastive reconstruction). If the autoencoder is trained, the encoder may be used to generate a compressed reference representation for a first image recording of a newly installed insect trap. This compressed reference representation is compared, during operation of the insect trap, with compressed representations of image recordings generated during operation and, in the event of a defined deviation, a message is output that a functional impairment is present. It is likewise possible to use the encoder together with the projection head directly for a classification.

Further techniques for classifying images are described for example in S.V.S. Prasad et al.: Techniques in Image Classification—A Survey, Global Journal of Researches in Engineering (F), 2015, Volume XV, Issue, VI, Version I, 17-32; K. Sanghvi et al.: A Survey on Image Classification Techniques, 2020, http://dx.doi.org/10.2139/ssrn.3754116 and may likewise be used to carry out the present invention.

The invention will be explained in more detail below with reference to drawings, without any intention to restrict the invention to the features or combinations of features illustrated in the drawings.

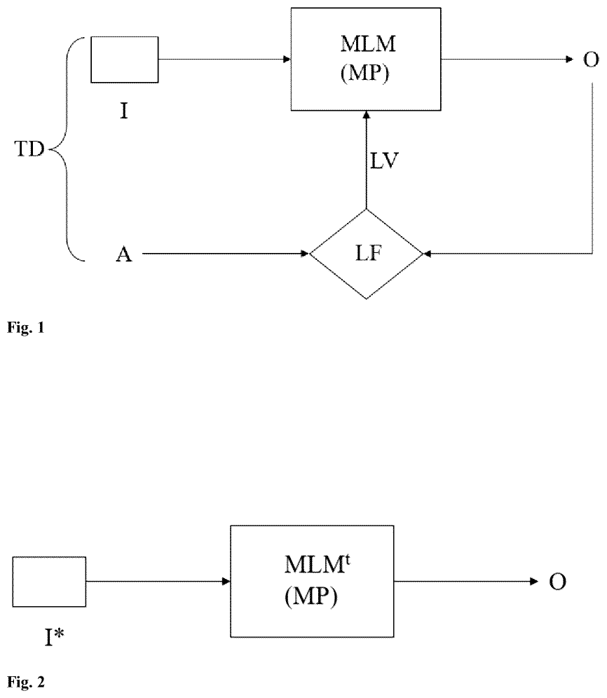

FIG. 1 schematically shows, by way of example, the training of a machine learning model. The machine learning model is trained using training data TD. The training data TD comprise a multiplicity of image recordings. Each image recording I shows a collection area of an insect trap (not illustrated in FIG. 1). The training data TD furthermore comprise, for each image recording I, information A as to whether the insect trap depicted in the image recording I has a functional impairment or whether it does not have a functional impairment. It is possible that the information A comprises information as to what specific functional impairment is present in the individual case and/or the seriousness of the functional impairment and/or the degree of severity of the functional impairment. In FIG. 1, for the sake of clarity, only one training dataset comprising an image recording I with information A is shown; however, the training data comprise a multiplicity of such training datasets. The image recording I constitutes input data for the machine learning model MLM. The information A constitutes target data for the machine learning model MLM. The image recording I is fed to the machine learning model MLM. The machine learning model MLM assigns the image recording to one of at least two classes. The assignment is carried out on the basis of the image recording I and on the basis of model parameters MP. The machine learning model MLM outputs information O that indicates the class to which the image recording has been assigned and/or the probability of the image recording having been assigned to one or more of the at least two classes. The output information O is compared with the information A. A loss function LF is used to quantify the deviations between the information O (output) and the information A (target data). For each pair consisting of information A and information O, a loss value LV may be computed. The loss value LV may be reduced in an optimization procedure (for example a gradient procedure) by modifying model parameters MP. The goal of the training may be to reduce the loss value for all image recordings to a predefined minimum. Once the predefined minimum has been reached, the training may be terminated.

FIG. 2 schematically shows the use of a trained machine learning model to recognize a functional impairment with an insect trap. The trained machine learning model MLM may have been trained in a training method, as has been described in relation to FIG. 1. A new image recording I* is fed to the trained machine learning model MLM^{t}. The new image recording I* shows a collection area of an insect trap. The model assigns the new image recording I* to one of the at least two classes for which the trained machine learning model MLM has been trained. The trained machine learning model MLM^{t} outputs information O that indicates the class to which the image recording has been assigned and/or the probability of the image recording having been assigned to one or more of the at least two classes. The information O may be output to a user.

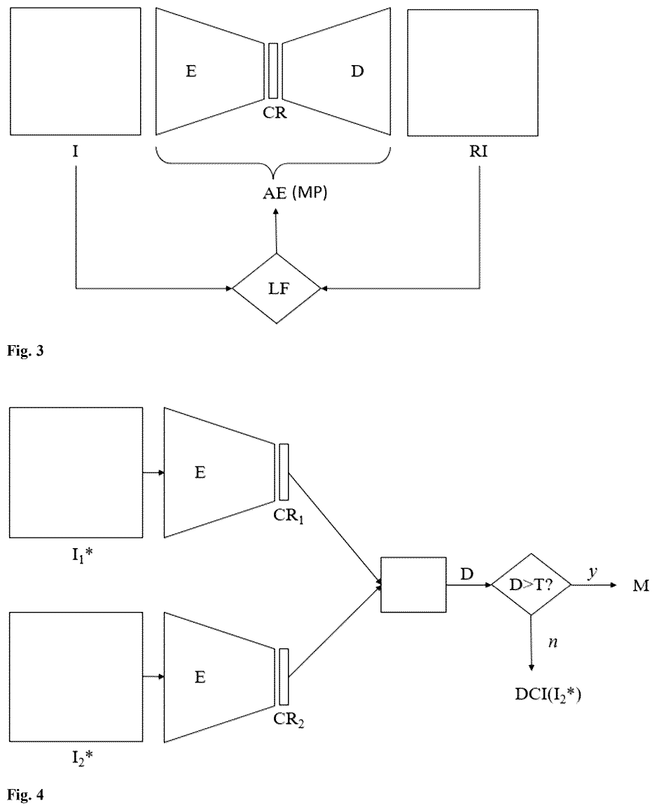

FIG. 3 schematically shows a further example of the training of a machine learning model. The machine learning model has an autoencoder architecture. The autoencoder AE comprises an encoder E and a decoder D. The encoder E is configured to generate a compressed representation CR for an image recording I on the basis of model parameters MP. The decoder D is configured, on the basis of the compressed representation CR and on the basis of model parameters MP, to generate a reconstructed image recording RI that is as close as possible to the image recording I. A loss function LF may be used to quantify deviations between the image recording I and the reconstructed image recording RI. The deviations may be minimized in an optimization procedure (for example in a gradient procedure) by modifying model parameters MP. The autoencoder AE is usually trained on the basis of a multiplicity of image recordings in an unsupervised learning procedure. FIG. 3 shows only one image recording I of the multiplicity of image recordings. Each image recording of the multiplicity of image recordings shows a collection area, or part thereof, of one or more insect traps. The one or more insect traps may have one or more functional impairments or be free from functional impairments.

FIG. 4 schematically shows a further example of the use of a trained machine learning model to recognize a functional impairment with an insect trap. The trained machine learning model may have been trained in a training method, as described in relation to FIG. 3. The trained machine learning model may be an encoder E of an autoencoder. The encoder E is illustrated twice in FIG. 4; however, it is the same encoder in both cases; it is illustrated twice just for the purpose of graphically illustrating the recognition method. In a first step, the encoder E is fed a first image recording I₁* of a collection area of an insect trap. The asterisk * indicates that the image recording I₁* was not used to train the machine learning model. The image recording I₁* is preferably an image recording of an insect trap without a functional impairment, which may have been generated for example after the installation of the insect trap. The encoder E is configured to generate a first compressed representation CR₁ for the first image recording I₁*. The first compressed representation CR₁ may be used as a reference representation. It may be stored in a data memory. During operation of the insect trap, further image recordings of the collection area of the insect trap are generated. FIG. 4 shows one of these further image recordings with the image recording I₂*. The image recording I₂* is also fed to the encoder E. The encoder E generates a second compressed representation CR₂ for the image recording I₂*. The first representation CR₁ and the second representation CR₂ are compared with one another in a next step. This comparison includes computing a distance metric D that quantifies the differences between the first representation CR₁ and the second representation CR₂. In a next step, the distance metric is compared with a predefined threshold value T. If the distance metric is greater than the predefined threshold value T (“γ”), a message M is output. The message M comprises information that the insect trap shown in the image recording I₂* has a functional impairment. If the distance metric is not greater than the predefined threshold value T (“n”), the image recording I₂* is fed to an analysis DCI(I₂*) in order to detect insects in the collection area of the insect trap and/or to count and/or identify the insects in the collection area.

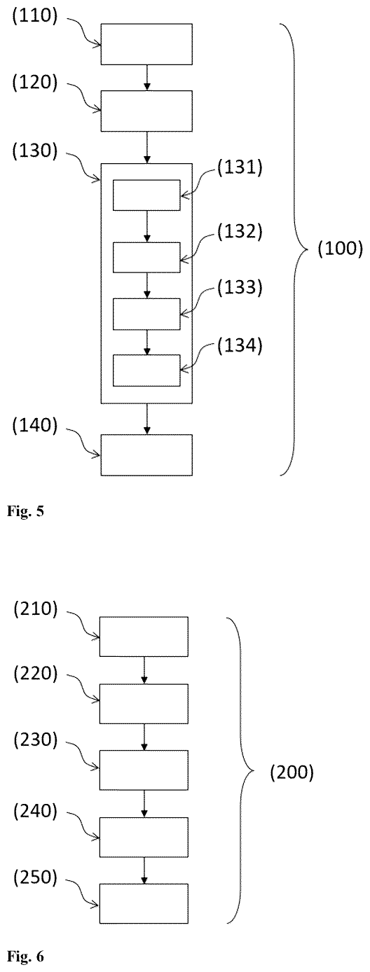

FIG. 5 schematically shows, by way of example, a computer-implemented method for training a machine learning model, in the form of a flowchart.

The Training Method (100) Comprises the Following Steps:
(110) receiving and/or providing training data, wherein the training data comprise input data and target data,
   wherein the input data comprise a multiplicity of image recordings of one or more insect traps, wherein each image recording shows at least part of a collection area of an insect trap,
   wherein the target data, for each image recording, comprise a class assignment, wherein the class assignment indicates the class of at least two classes to which the image recording is assigned, wherein at least one first class represents image recordings of insect traps that do not have a functional impairment and at least one second class represents image recordings of insect traps that have a functional impairment,
(120) providing a machine learning model, wherein the machine learning model is configured to assign the image recording to one of the at least two classes on the basis of an image recording and on the basis of model parameters;
(130) training the machine learning model with the training data, wherein the training comprises, for each image recording:
   (131) feeding the image recording to the machine learning model,
   (132) receiving an output from the machine learning model, wherein the output indicates the class to which the machine learning model has assigned the image recording and/or the probability of the machine learning model having assigned the image recording to one or more of the at least two classes,
   (133) determining a deviation between the output and the class assignment,
   (134) minimizing the deviation by modifying the model parameters,
(140) storing and/or outputting the trained machine learning model and/or using the trained machine learning model to recognize a functional impairment with a camera-monitored insect trap.

FIG. 6 schematically shows, by way of example, a computer-implemented method for recognizing a functional impairment with a camera-monitored insect trap.

The recognition method (200) comprises the following steps:
(210) receiving an image recording, wherein the image recording shows a collection area of an insect trap,
(220) providing a trained machine learning model, wherein the machine learning model is configured, and has been trained on the basis of training data, to assign image recordings to one of at least two classes, wherein the training data comprise input data and target data,
   wherein the input data comprise a multiplicity of image recordings of one or more insect traps, wherein each image recording shows at least part of a collection area of an insect trap,
   wherein the target data, for each image recording, comprise a class assignment, wherein the class assignment indicates the class of at least two classes to which the image recording is assigned, wherein at least one first class represents image recordings of insect traps that do not have a functional impairment and at least one second class represents image recordings of insect traps that have a functional impairment,
(230) feeding the image recording to a trained machine learning model,
(240) receiving information from the machine learning model as to the class to which the image recording has been fed;
(250) in the event that the image recording has been assigned to one of the at least one second class: outputting a message that the insect trap, shown at least partially in the image recording, has a functional impairment.

The steps, methods and/or functions described in this disclosure may be performed in whole or in part by a computer system.

A “computer system” is an electronic data processing system that processes data using programmable computing rules. Such a system typically comprises a “computer”, which is the unit that comprises a processor for performing logic operations, and peripherals.

In computer technology, “peripherals” denotes all devices that are connected to the computer and serve to control the computer and/or as input and output devices. Examples thereof are a monitor (screen), printer, scanner, mouse, keyboard, drives, camera, microphone, loudspeaker, etc. Internal ports and expansion cards are also regarded as peripherals in computer technology.

Modern computer systems are frequently divided into desktop PCs, portable PCs, laptops, notebooks, netbooks and tablet PCs, and what are known as handhelds (for example smartphones); all of these systems may be used to perform the invention.

The term “computer” is intended to be interpreted in the broad sense and encompass any type of electronic device with data processing capabilities, including, as non-limiting examples, personal computers, servers, embedded cores, communication devices, processors (for example digital signal processors (DSP), microcontrollers, field-programmable gate arrays (FPGA), application-specific integrated circuits (ASIC), etc.) and other electronic computing devices.

The term “process”, as used above, is intended to encompass any form of computing or manipulation or transformation of data that are represented as physical, for example electronic, phenomena and for example may occur or be stored in registers and/or memories of at least one computer or processor. The term “processor” encompasses a single processing unit or a multiplicity of distributed or remote units such as this.

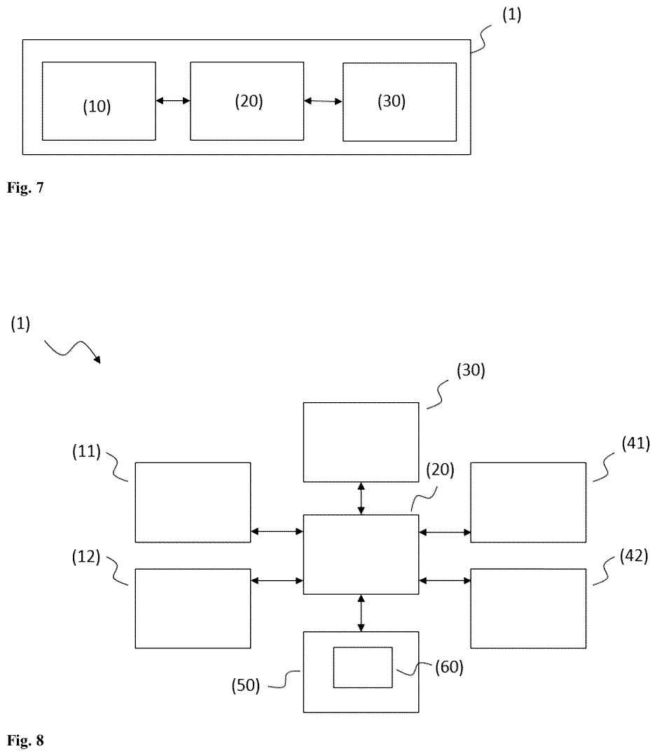

FIG. 7 schematically shows, by way of example, one embodiment of a computer system of the present disclosure. The computer system (1) comprises
an input unit (10),
a control and computing unit (20), and
an output unit (30).

The control and computing unit (20) is configured
to cause the input unit to receive an image recording, wherein the received image recording shows a collection area of an insect trap,
to feed the received image recording to a trained machine learning model, wherein the machine learning model is configured, and has been trained on the basis of training data, to assign image recordings to one of at least two classes, wherein the training data comprise input data and target data,
   wherein the input data comprise a multiplicity of image recordings of one or more insect traps, wherein each image recording shows at least part of a collection area of an insect trap,
   wherein the target data, for each image recording, comprise a class assignment, wherein the class assignment indicates the class of at least two classes to which the image recording is assigned, wherein at least one first class represents image recordings of insect traps that do not have a functional impairment and at least one second class represents image recordings of insect traps that have a functional impairment,
to receive information from the machine learning model as to the class of the at least two classes to which the image recording has been fed and/or the probability of the image recording having being assigned to one or more of the at least two classes,
to cause the output unit to output a message that the insect trap shown at least partially in the image recording has a functional impairment, if the image recording has been assigned to one of the at least one second classes.

FIG. 8 schematically shows, by way of example, a further embodiment of a computer system of the present disclosure.

The Computer System (1) Comprises a Processing Unit (20) Connected to a Memory (50).

The processing unit (20) may comprise one or more processors alone or in combination with one or more memories. The processing unit (20) may be standard computer hardware capable of processing information such as for example digital image recordings, computer programs and/or other digital information. The processing unit (20) typically consists of an arrangement of electronic circuits, some of which may be designed as an integrated circuit or as a plurality of integrated circuits connected to one another (an integrated circuit is sometimes also referred to as a “chip”). The processing unit (20) may be configured to execute computer programs that may be stored in a main memory of the processing unit (20) or in the memory (50) thereof or of another computer system.

The memory (50) may be standard computer hardware capable of storing information such as for example digital image recordings (for example representations of the area under investigation), data, computer programs and/or other digital information either temporarily and/or permanently. The memory (50) may comprise a volatile and/or non-volatile memory and may be fixedly installed or removable. Examples of suitable memories are RAM (random access memory), ROM (read-only memory), a hard disk, a flash memory, an exchangeable computer floppy disk, an optical disk, a magnetic tape or a combination of the aforementioned. Optical disks may include compact discs with read-only memory (CD-ROM), compact discs with a read/write function (CD-R/W), DVDs, Blu-Ray disks, and the like.

The processing unit (20) may be connected not only to the memory (50) but also to one or more interfaces (11, 12, 30, 41, 42) in order to display, transmit and/or receive information. The interfaces may comprise one or more communication interfaces (41, 42) and/or one or more user interfaces (11, 12, 30). The one or more communication interfaces (41, 42) may be configured such that they transmit and/or receive information, for example to and/or from an MRI scanner, a CT scanner, an ultrasound camera, other computer systems, networks, data memories or the like. The one or more communication interfaces (41, 42) may be configured such that they transmit and/or receive information over physical (wired) and/or wireless communication connections. The one or more communication interfaces (41, 42) may comprise one or more interfaces for connection to a network, for example using technologies such as mobile telephone, Wi-Fi, satellite, cable, DSL, optical fiber and/or the like. In some examples, the one or more communication interfaces (41, 42) may comprise one or more close-range communication interfaces configured such that they connect devices having close-range communication technologies such as NFC, RFID, Bluetooth, Bluetooth LE, ZigBee, infrared (for example IrDA) or the like The user interfaces (11, 12, 30) may comprise a display (30). A display (30) may be configured such that it displays information to a user. Suitable examples thereof are a liquid-crystal display (LCD), a light-emitting diode display (LED), a plasma display panel (PDP) or the like. The one or more user input interfaces (11, 12) may be wired or wireless and may be configured such that they receive information from a user in the computer system (1), for example for processing, storage and/or display. Suitable examples of user input interfaces (11, 12) are a microphone, an image-recording or video-recording device (for example a camera), a keyboard or a keypad, a joystick, a touch-sensitive surface (separate from a touchscreen or integrated therein) or the like. In some examples, the user interfaces may contain an automatic identification and data capture technology (AIDC) for machine-readable information. This may include barcodes, radiofrequency identification (RFID), magnetic strips, optical character recognition (OCR), integrated circuit cards (ICC) and the like. The user interfaces may also comprise one or more interfaces for communication with peripherals such as printers and the like.

One or more computer programs (60) may be stored in the memory (50) and executed by the processing unit (20), which is thereby programmed to perform the functions described in this description. The retrieving, loading and execution of instructions of the computer program (60) may take place sequentially, such that one instruction at a time is retrieved, loaded and executed. However, the retrieving, loading and/or execution may also take place in parallel.

1. A computer-implemented method comprising:
receiving an image recording, wherein the received image recording shows at least part of a collection area of an insect trap;
providing a trained machine learning model, wherein the machine learning model is configured, and has been trained on the basis of training data, to distinguish image recordings of insect traps with a functional impairment from image recordings of insect traps without a functional impairment;
feeding the received image recording to the trained machine learning model;
receiving information from the machine learning model, wherein the information indicates whether the image recording shows an insect trap with a functional impairment; and
in the event that the received image recording shows an insect trap with a functional impairment, outputting a message that the insect trap, shown at least partially in the received image recording, has a functional impairment.

2. The method as claimed in claim 1,
wherein the machine learning model is configured to assign image recordings to one of at least two classes, wherein the training data comprise input data and target data,
wherein the input data comprise a multiplicity of image recordings of one or more insect traps, wherein each image recording shows at least part of a collection area of an insect trap,
wherein the target data, for each image recording, comprise a class assignment, wherein the class assignment indicates the class of at least two classes to which the image recording is assigned, wherein at least one first class represents image recordings of insect traps that do not have a functional impairment and at least one second class represents image recordings of insect traps that have a functional impairment,
wherein receiving information from the machine learning model comprises: receiving information from the machine learning model as to the class to which the image recording has been fed.
wherein the message that the insect trap shown at least partially in the received image recording has a functional impairment is output when the received image recording has been assigned to one of the at least one second class.

3. The method as claimed in claim 2, wherein training the machine learning model, for each image recording of the multiplicity of image recordings, comprises:
inputting the image recording into the machine learning model, wherein the machine learning model is configured to assign the image recording to one of at least two classes on the basis of the input image recording and on the basis of model parameters;
receiving an output from the machine learning model, wherein the output indicates to which of the at least two classes the input image recording has been assigned by the machine learning model;
quantifying a deviation between the output and the class assignment of the training data; and
minimizing the deviation by modifying model parameters.

4. The method as claimed in claim 1,
wherein the machine learning model is configured and trained to assign the received image recording to one of multiple classes, wherein each class of a plurality of classes has a specific functional impairment,
wherein outputting the message comprises: outputting a message as to which specific functional impairment is present in the insect trap shown at least partially in the received image recording.

5. The method as claimed in claim 1,
wherein the machine learning model is configured and trained, on the basis of the received image recording, to output a probability, for one or more specific functional impairments, of the specific functional impairment occurring,
wherein outputting the message comprises: outputting a message as to the probability of the one or more specific functional impairments being present in the insect trap shown at least partially in the received image recording.

6. The method as claimed in claim 1,
wherein the machine learning model is configured and trained, on the basis of the received image recording, to output a degree of severity for one or more specific functional impairments,
wherein outputting the message comprises: outputting a message as to the degree of severity with which the one or more specific functional impairments is or are present in the insect trap shown at least partially in the received image recording.

7. The method as claimed in claim 1, wherein at least one of the functional impairment and the one or more specific functional impairments is selected from
a liquid level in the collection area has dropped below a lower threshold value,
a liquid level in the collection area has risen above an upper threshold value,
a collection area is contaminated,
a collection area is exhausted,
an algae formation in the collection area,
foam in the collection area,
ice formation or icing of liquids,
a field of view of the camera is restricted,
a camera and/or optical elements are contaminated,
an illumination source(s) defective and/or contaminated,
an occurrence of unwanted reflections,
a position and/or pose of components of the insect trap and/or the insect trap as a whole have changed,
a camera is defective, and
a camera does not generate images of the collection area.

8. The method as claimed in claim 1, wherein the machine learning model is configured and trained to generate a compressed representation for the received image recording, and wherein the method furthermore comprises:
quantifying a similarity and/or a difference between the compressed representation and a reference representation by computing a similarity metric and/or a distance metric,
wherein outputting the message comprises: outputting the message that the insect trap shown at least partially in the received image recording has a functional impairment when the similarity metric is below a predefined threshold value and/or the distance metric is above a predefined threshold value.

9. The method as claimed in claim 1, wherein the machine learning model is an artificial neural network or comprises same.

10. The method as claimed in claim 1, wherein the machine learning model is or comprises an encoder of an autoencoder.

11. The method as claimed in claim 1, wherein the method furthermore comprises:
only in the event that the received image recording shows an insect trap without a functional impairment, detecting, counting and/or identify insects in the collection area of the insect trap on the basis of the received image recording.

12. The method as claimed in claim 1, wherein the message furthermore comprises one or more of information:
a location of the insect trap,
information about which functional impairment is present,
information about the seriousness of the functional impairment,
information about what measures are able to be taken to restore full functionality of the insect trap,
information about when the measures should be taken in order to prevent a further functional impairment,
the received image recording.

13. A computer system comprising:
an input unit;
a control and computing unit; and
an output unit;
wherein the control and computing unit is configured to:
cause the input unit to receive an image recording, wherein the received image recording shows at least part of a collection area of an insect trap;
feed the received image recording to a machine learning model, wherein the machine learning model is configured, and has been trained on the basis of training data, to distinguish image recordings of insect traps with a functional impairment from image recordings of insect traps without a functional impairment;
receive information from the machine learning model, wherein the information indicates whether the received image recording shows an insect trap with a functional impairment; and
cause the output unit to output a message, wherein the message indicates that the insect trap, shown at least partially in the received image recording, has a functional impairment when the information output by the machine learning model indicates that the received image recording shows an insect trap with a functional impairment.

14. A non-volatile computer-readable storage medium storing software commands that, when executed by a processor of a computer system, cause the computer system to carry out the method as claimed in claim 1.

15. A system comprising:
an insect trap;
a camera;
a control unit;
an analysis unit;
a transmission unit; and
an output unit,
wherein the control unit is configured to cause the camera to generate one or more image recordings of a collection area of the insect trap,
wherein the analysis unit is configured to feed the one or more generated image recordings to a machine learning model, wherein the machine learning model is configured, and has been trained on the basis of training data, to distinguish image recordings of insect traps with a functional impairment from image recordings of insect traps without a functional impairment,
wherein the analysis unit is configured to receive information from the machine learning model, wherein the information indicates whether the one or more image recordings show an insect trap with a functional impairment,
wherein the transmission unit is configured to transmit the information and/or the one or more image recordings to a separate computer system,
wherein the output unit is configured to output the information.

16. A kit comprising an insect trap and a computer program product, wherein the insect trap comprises a camera or means for accommodating a camera, wherein the computer program product comprises program commands, wherein the program commands are able to be loaded into a main memory of a computer system, and cause the computer system to carry out the method as claimed in one claim 1.

17. The method as claimed in claim 9, wherein the artificial neural network is or comprises a convolutional neural network (CNN) and/or the artificial neural network is or comprises a transformer.
